(19) United States
(12) Patent Application Publication
(10) Pub. No.: US 2019/0276592 A1
(43) Pub. Date: Sep. 12, 2019

(54) DIACID MODIFIED COPOLYESTERS

(71) Applicants: EXXONMOBIL CHEMICAL PATENTS INC., BAYTOWN, TX (US); VIRGINIA TECH INTELLECTUAL PROPERTIES, INC., BLACKSBURG, VA (US)

(72) Inventors: Hans Eliot Edling, Blacksburg, VA (US); Haoyu Liu, Shanghai (CN); Ryan J. Mondshein, Blacksburg, VA (US); Timothy E. Long, Blacksburg, VA (US); S. Richard Turner, Blacksburg, VA (US); Ting Chen, Friendswood, TX (US)

(21) Appl. No.: 16/462,081

(22) PCT Filed: Oct. 18, 2017
(86) PCT No.: PCT/US17/57255

§ 371 Date: May 17, 2019

Related U.S. Application Data
(60) Provisional application No. 62/425,857, filed on Nov. 23, 2016.

(51) Int. Cl. C08G 63/199; C08G 63/185; D01F 6/84

(52) U.S. Cl. CPC C08G 63/199; D01F 6/84; C08G 63/185

(57) ABSTRACT

Copolyesters having improved properties based on 1,4 cyclohexanedimethanol (CHDM) or neopentyl glycol (NPG), and a diacid component containing a combination of two diacids selected from 4,4′-biphenyl dicarboxylic acid, 3,4′-biphenyl dicarboxylic acid, and terephthalic acid; methods of making the copolyesters; and shaped articles made of the copolyesters. Also, polyesters based N on biphenyl dicarboxylic acid and NPG; methods of making the polyesters; and shaped articles made of the polyesters

### CROSS-REFERENCE TO RELATED APPLICATION

This application claims priority to and the benefit of provisional application U.S. 62/425,857 filed Nov. 23, 2016, which is incorporated by reference herein in its entirety.

### THE NAMES OF PARTIES TO A JOINT RESEARCH AGREEMENT

ExxonMobil Chemical Company, a division of ExxonMobil Corporation, and Virginia Polytechnic Institute and State University.

### BACKGROUND OF THE INVENTION

Amorphous copolyesters are important modern materials for numerous critical applications ranging from clear plastics for signs, transparent medical IV connectors, to transparent containers for food storage, and so on. The industry is ever in search of new polymers with a high glass transition temperature (T_{g}), as well as impact strength and other properties suitable for high performance applications. For example, bisphenol-A based polycarbonate (BPA PC) exhibits T_{g} near 145° C., making it suitable for dishwasher cleaning and sterilization processes.

High performance monomers such as 1,4-cyclohexanedimethanol (CHDM) and to a more limited extent, 2,2′-dimethyl-1,3-propane diol (NPG), have been used in some polyesters to enhance toughness, enhance resistance to hydrolytic degradation, and in some cases, enhance stability to weathering by UV. Poly(ethylene terephthalate) (PET) modified with less than 50 mol % of CHDM (or, as polymerized, 1,4-cyclohexylenedimethylene) (PETG), and poly(1,4-cyclohexylenedimethylene terephthalate) (PCT) modified with less than 50 mol % ethylene glycol (PCTG), are examples of such polyesters.

Also, mixtures of more than one diacid have been used in combination with a single diol, in diacid modified amorphous copolyesters (versus PETG or PCTG), in an effort to reduce crystallization rates and offer limited control of the glass transition temperature (“Tg”). Copolymers of 4,4′-biphenyl dicarboxylic acid (4,4′-BB) and terephthalic acid with a diol such as ethylene glycol are known from Krigbaum et al., Journal of Polymer Science, Polym. Letters, 20, 109 (1982); U.S. Pat. No. 4,082,731; and WO 2015/112252. The amorphous copolyesters of 4,4′-BB and terephthalate with ethylene glycol generally contain high levels of terephthalate, and can have undesirably low glass transition temperatures and/or poor tensile properties such as toughness. When more 4,4′-BB is incorporated in an effort to elevate the glass transition temperature or improve other properties, the copolyester becomes semicrystalline.

The industry thus has a need for further enhancement of the Tg and/or other properties, e.g., more than could be obtained or expected from diacid modification of conventional copolyesters of terephthalate, isophthalate, and the like.

### SUMMARY OF THE INVENTION

This summary is provided to introduce a selection of concepts that are further described below in the detailed description. This summary is not intended to identify key or essential features of the claimed subject matter, nor is it intended to be used as an aid in limiting the scope of the claimed subject matter.

In any embodiment of the invention, a copolyester can comprise: a diol component comprising a diol selected from one of 1,4-cyclohexanedimethanol (CHDM) and neopentyl glycol (NPG); and a diacid component comprising a combination of first and second diacids selected from the group consisting of 4,4′-biphenyl dicarboxylate, 3,4′-biphenyl dicarboxylate, and terephthalate.

In any embodiment of the invention, a method can comprise contacting (i) a diol component comprising a diol selected from one of CHDM and NPG; with (ii) a diacid component comprising: a combination of first and second diacids selected from 4,4′-biphenyl dicarboxylic acid (4,4′-BB), 3,4′-biphenyl dicarboxylic acid (3,4′-BB), and terephthalic acid, or ester producing equivalents thereof, in the presence of (iii) a catalyst; and forming a copolyester comprising the diol component and the diacid component.

In any embodiment of the invention, a polyester may comprise a diol component comprising neopentyl glycol (NPG); and a biphenyl dicarboxylate, preferably selected from 4,4′-biphenyl dicarboxylate and 3,4′-biphenyl dicarboxylate.

### DETAILED DESCRIPTION OF THE PREFERRED EMBODIMENTS

Throughout the entire specification, including the claims, the following terms shall have the indicated meanings.

The term “and/or” refers to both the inclusive “and” case and the exclusive “or” case, and such term is used herein for brevity. For example, a composition comprising “A and/or B” may comprise A alone, B alone, or both A and B.

The percentages of monomers are expressed herein as mole percent (mol %) based on the total moles of monomers present in the reference polymer or polymer component. All other percentages are expressed as weight percent (wt %), based on the total weight of the particular composition present, unless otherwise noted. Room temperature is 25° C.±2° C. and atmospheric pressure is 101.325 kPa unless otherwise noted.

The term “consisting essentially of” in reference to a composition is understood to mean that the composition can include additional compounds other than those specified, in such amounts to the extent that they do not substantially interfere with the essential function of the composition, or if no essential function is indicated, in any amount up to 5 percent by weight of the composition.

For purposes herein, a “polymer” refers to a compound having two or more “mer” units (polyester mer units are esters derived from a diacid and a diol, as discussed below), that is, a degree of polymerization of two or more, where the mer units can be of the same or different species. A “homopolymer” is a polymer having mer units or residues that are the same species, e.g., a homopolyester has ester residues derived from a single diacid and a single diol. A “copolymer” is a polymer having two or more different species of mer units or residues, e.g., a copolyester has more than one species of ester residues derived from more than one diacid and/or more than one diol. A “terpolymer” is a polymer having three different species of mer units. “Different” in reference to mer unit species indicates that the mer units differ from each other by at least one atom or are different isomerically. Unless otherwise indicated, reference to a polymer herein includes a copolymer, a terpolymer, or any polymer comprising a plurality of the same or different species of repeating units.

The term “polyester,” as used herein, refers to a polymer comprised of residues derived from one or more polyfunctional acid moieties, collectively referred to herein as the “diacid component,” in ester linkage with residues derived from one or more polyhydroxyl compounds, which may also be referred to herein as “polyols” and collectively as the “diol component.” The term “repeating unit,” also referred to as the “mer” units, as used herein with reference to polyesters refers to an organic structure having a diacid component residue and a diol component residue bonded through a carbonyloxy group, i.e., an ester linkage. Reference to the equivalent terms “copolyesters” or “(co)polyesters” or “polyester copolymers” herein is to be understood to mean a polymer prepared by the reaction of two or more different diacid compounds or ester producing equivalents thereof that incorporate different diacid residues into the backbone, and/or two or more different diol compounds that incorporate different diol residues into the backbone, i.e., either one or both of the diacid and diol components incorporate a combination of different species into the polymer backbone.

As used herein, the prefixes di- and tri-generally refer to two and three, respectively, with the exception of diacid and diol components noted herein. Similarly, the prefix “poly-” generally refers to two or more, and the prefix “multi-” to three or more. The carboxylic acids and/or esters used to make the copolyesters, or the residues of which are present therein, are collectively referred to herein as the “diacid component,” including both difunctional and multifunctional species thereof, or simply as the “acid component;” and likewise the hydroxyl compounds used to make the copolyesters, or the residues of which are present therein, are collectively referred to herein as the “diol component,” including both difunctional and multifunctional species thereof, or simply as the hydroxyl or polyol component.

The polycarboxylic acid residues, e.g., the dicarboxylate mer units, may be derived from a polyfunctional acid monomer or an ester producing equivalent thereof. Examples of ester producing equivalents of polyfunctional acids include one or more corresponding acid halide(s), ester(s), salts, the anhydride, or mixtures thereof. As used herein, therefore, the term “diacid” is intended to include polycarboxylic acids and any derivative of a polycarboxylic acid, including its associated acid halides, esters, half-esters, salts, half-salts, anhydrides, mixed anhydrides, or mixtures thereof, capable of forming esters useful in a reaction process with a diol to make polyesters.

As used herein, a “branching agent” is a multifunctional compound, e.g., a multifunctional carboxylic acid, that causes or promotes the formation of branches in the growth of the polyester chain. A branching agent can be, for example, either a multifunctional hydroxyl component or a multifunctional acid component, or comprise a mixture of functionalities. Multifunctional hydroxyl branching agents can include, for example, triols such as glycerol, trimethylolpropane, ditrimethylol propane, trimethylolethane, pentaerythrytol, dipentaerythrytol, glycerol, and so on. Multifunctional acid component branching agents can include, for example, trimellitic and/or pyromellitic anhydrides or acids, and the like, and their esters and ester producing equivalents thereof, and the like, in which the anhydride functional group(s) reacts to form two carboxylic acid or carboxylate groups. Furthermore, the term “branching agent” may include multifunctional compounds having a total number of mixed carboxylic acid and/or hydroxyl groups of three or more, e.g., two acid groups and one hydroxyl group, or one acid group and two hydroxyl groups, and the like.

The term “residue,” as used herein, means the organic structure of the monomer in its as-polymerized form as incorporated into a polymer, e.g., through a polycondensation and/or an esterification or transesterification reaction from the corresponding monomer. Throughout the specification and claims, reference to the monomer(s) in the polymer is understood to mean the corresponding as-polymerized form or residue of the respective monomer. For purposes herein, it is to be understood that by reference to a copolyester comprising a diacid component and a diol component, the diacid and diol components are present in the polymer in the as-polymerized (as-condensed) form. For example, the diacid component is present in the polymer as dicarboxylate in alternating ester linkage with the diol component, yet the polyester may be described as being comprised of, for example, the dicarboxylic acid or dicarboxylic acid alkyl ester and diol, where it is understood the alkyl ester groups in the starting material are not present in the polyester. For example, the diacid component is present in the polymer in alternating ester linkage with the diol component, yet the polyester may be described as being comprised of, for example, the dicarboxylic acid or dicarboxylic acid alkyl ester and diol, e.g., terephthalic acid-ethylene glycol polyester or dimethylterephthalate-ethylene glycol polyester, where it is understood the acid or methyl ester groups in the starting material are not present in the polyester.

Mole percentages of the diacid and diol components are expressed herein based on the total moles of the respective component, i.e., the copolyesters comprise 100 mole percent of the polyfunctional acid component and 100 mole percent of the polyfunctional hydroxyl component. For purposes herein, when a composition specifies a component, for example, a diacid component, having a particular mole percent of a first compound with the balance or remainder of another compound or mixture of compounds, it is to be understood that the balance refers to the amount of the second compound necessary to equal 100 mole percent of that component, based on the total number of moles of all diacid compounds present, typically in polymerized form in the resultant copolyester. For example, a copolyester having a first diacid “A” from 30 to 60 mole percent with the balance being the second diacid component “B” refers to a copolyester comprising 30 to 60 mole percent diacid A and 70 to 40 mole percent diacid B. In any embodiment where the diacid B may include at least one of a plurality of diacids B1 or B2, the 70 to 40 mole percent of diacid B refers to any combination of diacids B1 and B2 necessary to equal the required 70 to 40 mole percent of the total number of moles of all the diacid compounds present in polymerized form in the subject copolyester. Mole percentages of a branching agent are based on the total moles of repeating (ester-linked diacid-diol) units.

Unless indicated otherwise, for purposes herein an essentially amorphous polymer is defined as a polymer that does not exhibit a substantially crystalline melting point, Tm, i.e., no discernable heat of fusion or a heat of fusion less than 5 J/g, when determined by a heat/cool/reheat differential scanning calorimetry (DSC) analysis from the second heating ramp by heating of the sample from 0° C. to 300° C. at a heating and cooling rate of 10° C./min. The sample is held for 3 min between heating and cooling scans. For purposes herein an amorphous polymer may alternatively be indicated if injection molding of the polymer produces an article which is essentially clear, wherein the injection molding process used is known to produce articles having cloudy or opaque character upon injection molding of a semi-crystalline polymer having similar properties to the amorphous polymer.

Conversely, a polymer exhibiting a crystalline melting point may be referred to herein as crystalline or, as is more common for polyesters, referred to herein as semicrystalline. A semicrystalline polymer often contains at least 5 weight percent of a region or fraction having a crystalline morphology and at least 5 weight percent of a region or fraction having an amorphous morphology. Semicrystalline polyesters often have up to 40 weight percent crystallinity and 60 weight percent or more of amorphous morphology.

For purposes herein, the melting temperature, crystallization temperature, glass transition temperature, etc., are determined by a heat/cool/reheat DSC analysis from the second heating ramp by heating of the sample from 0° C. to 300° C. at a heating and cooling rate of 10° C./min. The sample is held for 3 min between heating and cooling scans. The melting, crystallization, and glass transition temperatures are measured as the midpoint of the respective endotherm or exotherm in the second heating ramp.

Unless indicated otherwise, inherent viscosity is determined in 0.5% (g/dL) dichloroacetic acid solution at 25° C. by means of a CANNON TYPE B glass capillary viscometer, adapted from ASTM method D4603. Inherent viscosity at 0.5 g/dL dichloroacetic acid solution was used to calculate intrinsic viscosity according to the method outlined by Schiraldi et al. (cf. Ma H, Hibbs M, Collard D M, Kumar S, and Schiraldi D A. Macromolecules 2002; 35(13):5123-5130.) Inherent viscosity (ηᵢₙₕ) is calculated as the ratio of the natural logarithm of the relative viscosity to the mass concentration of the polymer according to the equation (A):

$${η}_{inh} = \frac{ln {η}_{rel}}{c} \qquad ( A )$$

where c is the mass concentration of the polymer (g/dL) and ηᵣₑₗ is the relative viscosity, which is determined according to the equation (B):

$${η}_{rel} = \frac{η}{{η}_{0}} \qquad ( B )$$

where η is the viscosity of the solution and η₀ is the viscosity of the neat solvent. Unless otherwise specified, inherent viscosity is expressed as dL/g.

It is to be understood that for purposes herein, a polymer referred to as a “bibenzoate” comprises a diacid component comprising residues derived from a biphenyl dicarboxylic acid or ester producing equivalent thereof, such as, for example, 4,4′-biphenyl dicarboxylic acid or ester producing equivalent thereof as disclosed herein, 3,4′-biphenyl dicarboxylic acid or ester producing equivalent thereof as disclosed herein, or the combination thereof.

The difunctional hydroxyl compound can be a dihydric alcohol such as, for example, glycols and diols. The term “glycol” as used in this application includes, but is not limited to, diols, glycols, and/or multifunctional hydroxyl compounds. In any embodiment, the difunctional hydroxyl compound may be an alicyclic or aromatic nucleus bearing two hydroxyl substituents such as, for example, 2,2%4,4′-tetramethyl-1,3-cyclobutanediol (TMCBD), 1,4-cyclohexanedimethanol (CHDM), as the cis or trans isomers, or a combination of cis and trans isomers, hydroquinone bis(betahydroxyethyl) ether, and/or the like.

For purposes herein, a polymer is “essentially free of crosslinking” if it contains no more than 5 weight percent gel by weight of the polymer. In any embodiment herein, the polyester may be essentially free of crosslinking.

The following abbreviations are used herein: ASTM is ASTM International, formerly the American Society for Testing and Materials; 3,4′BB is 3,4′-biphenyl dicarboxylic acid or an ester producing analog such as dimethyl 3,4′-biphenyldicarboxylate; 4,4′BB is 4,4′-biphenyl dicarboxylic acid or an ester producing analog such as dimethyl 4,4′-biphenyldicarboxylate; BPA is bisphenol A; CHDM is 1,4-cyclohexanedimethanol; DCA is dichloroacetic acid; DEG is diethylene glycol; DMA is dynamic mechanical analysis; DMT is dimethyl terephthalate; T refers to terephthalic acid; DMI is dimethyl isophthalate; I refers to isophthalic acid; DSC is differential scanning calorimetry; EG is ethylene glycol; GPC is gel permeation chromatograph; HDT is heat distortion temperature; NPG is neopentyl glycol, 2,2-dimethyl-1,3-propanediol; PC is bisphenol A polycarbonate; PCT is poly(1,4-cyclohexylenedimethylene terephthalate); PCTG is PCT modified with less than 50 mol % ethylene glycol; PEN is polyethylene naphthalate; PET is polyethylene terephthalate; PETG is PET modified with less than 50 mol % of 1,4-cyclohexylenedimethylene; TFA is trifluoroacetic acid; TFA-d is deuterated trifluoroacetic acid; the letter “d” prior to a chemical name also indicates a deuterated compound; TGA is thermogravimetric analysis; CDCl₃ is deuterated chloroform; THF is tetrahydrofuran; TMA is trimellitic anhydride; and TMCBD is 2,2′,4,4′-tetramethyl-1,3-cyclobutanediol. For purposes herein, unless otherwise specified, reference to terephthalate and/or isophthalate is used interchangeably with terephthalic acid and isophthalic acid, respectively.

Polyesters according to any embodiment herein may be prepared from reaction of a diacid component and a diol component, which react in substantially equal molar proportions and are incorporated into the polyester polymer as their corresponding residues (i.e., in polymerized form). The polyesters useful in the present invention, therefore, can contain substantially equal molar proportions of acid residues and diol residues such that the total moles of repeating units of a diacid in which one of the two acid groups is esterified with one of the two hydroxyl groups of the diol are equal to 100 mole percent. The mole percentages provided in the present invention, therefore, may be based on the total moles of acid residues, the total moles of diol residues, or the total moles of repeating units unless otherwise indicated.

In any embodiment of the present invention, a copolyester can comprise: a diol component comprising a diol selected from one of CHDM and NPG; and a diacid component comprising a combination of first and second ones of 4,4′-biphenyl dicarboxylate (derived from 4,4′-BB or ester producing equivalent thereof), 3,4′-biphenyl dicarboxylic acid (derived from 3,4′-BB or ester producing equivalent thereof), and terephthalate (derived from terephthalic acid or ester producing equivalent thereof).

In any embodiment of the present invention, the diol component can comprise, consist essentially of, or consist of CHDM. If desired, a relatively minor amount of another diol may be used that does not significantly affect the properties of the copolyester, e.g., up to 5 mole percent, or up to 1 mole percent, of the diol component may comprise another diol selected from a C₂ to C₂₀ alkylene diol, e.g., ethylene glycol, 1,3-propanediol, 1,4-butanediol, 1,6-hexanediol, NPG, or a combination thereof, based on the total moles of the diol component in the copolyester, e.g., in an amount that does not substantially detract from the improvement in properties by using CHDM as the diol component. In any embodiment, the CHDM can be present in the copolyester as a combination of cis isomers and trans isomers having a molar cis:trans ratio wherein the cis isomer is present at from 1 to 99 mole percent with the balance being the trans isomer. In any embodiment, the cis isomer is preferably present at greater than or equal to about 10 mol percent, or 20 mol percent, or 30 mol percent, or 40 mol percent, or 50 mol percent, or 60 mol percent, or 70 mol percent, or 80 mol percent, with the balance being in the trans isomer, determined using 41 NMR in d-trifluoroacetic acid/CDCl₃, based on the total moles of the CHDM component in the copolyester.

In any embodiment, the diol component can comprise, consist essentially of, or consist of NPG. If desired, a relatively minor amount of another diol may be used that does not significantly affect the properties of the copolyester, e.g., up to 5 mole percent, or up to 1 mole percent, of the diol component may comprise a second diol selected from another C₂ to C₂₀ alkylene diol, e.g., ethylene glycol, 1,3-propanediol, 1,4-butanediol, or 1,6-hexanediol, or CHDM, or a combination thereof, based on the total moles of the diol component in the copolyester, e.g., in an amount that does not substantially detract from the improvement in properties by using NPG as the diol component.

In any embodiment of the present invention, the diacid component can comprise, consist essentially of, or consist of the first and second diacids selected from the group consisting of 4,4′-biphenyl dicarboxylate, 3,4′-biphenyl dicarboxylate, and terephthalate, e.g., from about 10 to 90 mole percent of the first diacid and about 90 to 10 mole percent of the second diacid, based on the total moles of the diacid component. In any embodiment, the first diacid preferably comprises a lower limit selected from about 10, or 20, or 30, or 40, or 50, or 60, or 65, or 70, or 75, or 80 mole percent, up to any higher limit of about 99, or 90, or 85, or 75, or 70, or 65, or 60, or 55, or 50, or 45, or 40, or 30, or 25, or 20 mole percent, based on the total moles of the diacid component, with the balance of the diacid component being the second diacid. If desired, a relatively minor amount of other diacids may be used that does not significantly affect the properties of the copolyester, e.g., up to 5 mole percent, or up to 1 mole percent, of the diacid component may comprise other diacids, e.g., isophthalate, and/or other diacids selected from the group consisting of 4,4′-biphenyl dicarboxylate, 3,4′-biphenyl dicarboxylate, and terephthalate, based on the total moles of the diacid component in the copolyester, e.g., in an amount that does not substantially detract from the improvement in properties by using the first and second diacids as the diacid component.

In any embodiment of the present invention, the diacid component preferably comprises from about 10 to 90 mole percent 4,4′-biphenyl dicarboxylate and from about 90 to 10 mole percent terephthalate, based on the total moles of the diacid component in the copolyester. For example, the diacid component may comprise 20 mole percent or more, or 30 mole percent or more, or 40 mole percent or more of 4,4′-biphenyl dicarboxylate, where the balance of the diacid component is terephthalate, based on the total moles of the diacid component in the copolyester. If desired, the diacid component may further comprise up to 5 mole percent, or up to 2 mole percent, or up to 1 mole percent, of isophthalate, 3,4′-biphenyl dicarboxylate, or a combination thereof, based on the total moles of the diacid component in the copolyester, e.g., in an amount that does not substantially detract from the improvement in properties by using 4,4′-biphenyl dicarboxylate and terephthalate as the diacid component.

In any embodiment of the present invention, the diacid component preferably comprises from about 10 to 90 mole percent 3,4′-biphenyl dicarboxylate and from about 90 to 10 mole percent terephthalate, based on the total moles of the diacid component in the copolyester. For example, the diacid component may comprise 20 mole percent or more, or 30 mole percent or more, or 40 mole percent or more of 3,4′-biphenyl dicarboxylate, where the balance of the diacid component is terephthalate, based on the total moles of the diacid component in the copolyester. If desired, the diacid component may further comprise up to 5 mole percent, or up to 2 mole percent, or up to 1 mole percent, of isophthalate, 4,4′-biphenyl dicarboxylate, or a combination thereof, based on the total moles of the diacid component in the copolyester, e.g., in an amount that does not substantially detract from the improvement in properties by using 4,4′-biphenyl dicarboxylate and terephthalate as the diacid component.

In any embodiment of the present invention, the diacid component preferably comprises from about 10 to 90 mole percent 4,4′-biphenyl dicarboxylate and from about 90 to 10 mole percent 3,4′-biphenyl dicarboxylate, based on the total moles of the diacid component in the copolyester. For example, the diacid component may comprise 20 mole percent or more, or 30 mole percent or more, or 40 mole percent or more of 4,4′-biphenyl dicarboxylate, where the balance of the diacid component is 3,4′-biphenyl dicarboxylate, based on the total moles of the diacid component in the copolyester. If desired, the diacid component may further comprise up to 5 mole percent, or up to 2 mole percent, or up to 1 mole percent, of isophthalate, terephthalate, or a combination thereof, based on the total moles of the diacid component in the copolyester, e.g., in an amount that does not substantially detract from the improvement in properties by using 4,4′-biphenyl dicarboxylate and 3,4′-biphenyl dicarboxylate as the diacid component.

In any embodiment of the present invention, the copolyesters can comprise an number average molecular weight of equal to or greater than about 5,000 g/mol (or equal to or greater than 8,000, or equal to or greater than 10,000, or equal to or greater than 12,000, or equal to or greater than 15,000, or equal to or greater than 20,000, or equal to or greater than 30,000, or equal to or greater than 40,000, or equal to or greater than 50,000 g/mol); and/or a polydispersity of greater than 1.75 up to 3.5 (or from 1.8 up to 3, or from 1.8 to 2.5, or from 1.9 to 2.5, or about 2.0) where Mn and polydispersity are determined by GPC or calculated from the inherent viscosity. In the event of a conflict, the calculation from inherent viscosity shall control. In any embodiment of the invention, the polymer preferably comprises an inherent viscosity equal to or greater than about 0.5 dL/g, or equal to or greater than 0.7 dL/g, or equal to or greater than 0.8 dL/g; and/or less than or equal to about 1 dL/g, or less than or equal to about 0.9 dL/g.

In any embodiment the copolyesters preferably comprise a glass transition temperature equal to or greater than about 90° C., or greater than about 95° C., or greater than about 100° C., or greater than about 105° C., or greater than about 110° C., or equal to or greater than about 112° C., or equal to or greater than about 114° C., or equal to or greater than about 115° C., or equal to or greater than about 116° C., or equal to or greater than about 118° C., or equal to or greater than about 120° C., or equal to or greater than about 125° C., or equal to or greater than about 130° C., or up to about 135° C. or greater.

Often, the copolyesters can exhibit a zero shear melt viscosity of less than 1700 Pa·s, or less than 1500 Pa·s, or less than 1300 Pa·s, or less than 1100 Pa·s, determined according to ASTM D3835 at 275° C.

Often, the copolyesters can comprise an essentially amorphous morphology, e.g., the polymer does not comprise a measurable crystallization temperature Tc and/or does not comprise a discernable melting temperature Tm.

Often, the copolyesters can comprise a semicrystalline morphology. In any embodiment, the polymer preferably comprises relative amounts of 4,4′-biphenyl dicarboxylate, 3,4′-biphenyl dicarboxylate, terephthalate, and/or isophthalate sufficient to produce a melting point peak, a crystallization point peak, or both. When the copolyester is semi-crystalline, it preferably has a melting point of less than 270° C., or less than 260° C., or less than 250° C., or less than 240° C., or less than 235° C.

Often, the polyester copolymer can comprise less than or equal to about 20 weight percent crystallinity, or less than or equal to about 10 weight percent crystallinity, or less than or equal to about 5 weight percent crystallinity, or less than or equal to about 1 weight percent crystallinity, determined by DSC analysis from a second heating ramp at a heating rate of 10° C./min.

It is expected that the copolyesters, according to the present invention, have an elongation to break greater than 100%, when determined according to ASTM D638; and/or a tensile stress at a break of greater than 50 MPa, when determined according to ASTM D638; and/or a yield stress of greater than 45 MPa, when determined according to ASTM D638; and/or a Young's modulus greater than 1.7 GPa, when determined according to ASTM D638; and/or a semi-crystalline morphology, preferably having a melting point of less than 260° C., or less than 250° C., or less than 240° C., or less than 235° C.; and/or an inherent viscosity of greater than 0.7 dL/g; and/or an essentially amorphous morphology, preferably having a glass transition temperature greater than 120° C., and preferably having a zero shear melt viscosity of less than 1700 Pa·s (or less than 1500 Pa·s, or less than 1300 Pa·s, or less than 1100 Pa·s) determined according to ASTM D3835 at 275° C.

Preferably, the Tm is less than the lowest Tm of the corresponding copolyesters made with a single diacid, preferably at least 20° C. less or at least 30° C. less than either of the corresponding single-diol copolyesters having a single diacid component.

Preferably, the copolyester comprises an oxygen permeability coefficient less than or equal to about 4, or less than or equal to about 2.5, or less than or equal to about 2, or less than or equal to about 1.5, or less than or equal to about 1 cm³-cm/m²-atm-day, determined at 23° C.

Often, the copolyester can exhibit an elongation at break of equal to or greater than about 70%, or 80%, or 90%, or 100%, or 105%, or 110%, or 120%, or 130%, or 150%, determined according to ASTM D638.

Often, the copolyester can exhibit a tensile strength, also referred to as a tensile stress, of equal to or greater than about 45 MPa, or 50 MPa, or 55 MPa, or 60 MPa, determined according to ASTM D638.

Often, the copolyester can exhibit a yield stress of equal to or greater than about 30 MPa, or 35 MPa, or 40 MPa, or 45 MPa, determined according to ASTM D638.

Often, the copolyester can comprise a Young's Modulus of equal to or greater than about 1.6 GPa, or 1.7 GPa, or 1.9 GPa, or 2.0 GPa, or 2.05 GPa, determined according to ASTM D638.

Often, the polyester copolymer can exhibit a thermal degradation temperature (Td) of equal to or greater than about 300° C., or equal to or greater than about 350° C., or equal to or greater than about 375° C., or equal to or greater than about 400° C., at 5 weight percent as determined according to ASTM D3850 by thermogravimetric analysis.

Often, the polymer can exhibit a tensile modulus (without extensometer) of equal to or greater than about 1200 MPa, or equal to or greater than about 1300 MPa, or equal to or greater than about 1400 MPa, or equal to or greater than about 1500 MPa, determined according to ASTM D638.

Often, the polymer can exhibit a flexural strength of equal to or greater than about 65 MPa, or equal to or greater than about 70 MPa, or equal to or greater than about 75 MPa, determined according to ASTM D638.

Often, the polymer can exhibit a flexural modulus of equal to or greater than about 1500 MPa, or equal to or greater than about 1800 MPa, or equal to or greater than about 2000 MPa, or equal to or greater than about 2200 MPa, equal to or greater than about 2400 MPa, determined according to ASTM D638.

The heat distortion temperature (HDT) is the temperature at which a sample deforms under a specified load of 455 kPa or 1.82 MPa, determined according to ASTM D648. Often, the copolyester can comprise an HDT at 455 kPa of equal to or greater than about 65° C., or equal to or greater than about 70° C., or equal to or greater than about 75° C., or equal to or greater than about 80° C., or equal to or greater than about 90° C., or equal to or greater than about 100° C., or equal to or greater than about 105° C., determined according to ASTM D648. Often, the polyester copolymer can comprise an HDT at 1.82 MPa of equal to or greater than about 60° C., or equal to or greater than about 65° C., or equal to or greater than about 70° C., or equal to or greater than about 75° C., or equal to or greater than about 80° C., or equal to or greater than about 90° C., determined according to ASTM D648.

Preferably, the diol consists essentially of CHDM or NPG, and the diacid component consists essentially of the first and second diacids, for example, the copolyester can be poly(4,4′-biphenyl dicarboxylate-co-3,4′-biphenyl dicarboxylate)-CHDM, or poly(4,4′-biphenyl dicarboxylate-co-terephthalate)-CHDM, or poly(3,4′-biphenyl dicarboxylate-co-terephthalate)-CHDM, or poly(4,4′-biphenyl dicarboxylate-co-3,4′-biphenyl dicarboxylate)-NPG, or poly(4,4′-biphenyl dicarboxylate-co-terephthalate)-NPG, or poly(3,4′-biphenyl dicarboxylate-co-terephthalate)-NP G.

For example, when the diol component consists essentially of CHDM, the diacid component may comprise from about 10 to 90 (or 20 to 80, or 30 to 70) mole percent 4,4′-biphenyl dicarboxylate, and from about 90 to 10 (or 80 to 20, or 70 to 30) mole percent terephthalate; or from about 10 to 90 (or 20 to 80, or 30 to 70) mole percent 3,4′-biphenyl dicarboxylate, from about 90 to 10 (or 80 to 20, or 70 to 30) mole percent terephthalate; or from about 10 to 90 (or 20 to 80, or 30 to 70) mole percent 4,4′-biphenyl dicarboxylate, from about 90 to 10 (or 80 to 20, or 70 to 30) mole percent 3,4′-biphenyl dicarboxylate; all based on the total moles of the diacid component.

Preferably, the diol component is CHDM; and the diacid component consists essentially of 4,4′-biphenyl dicarboxylate and terephthalate, and/or the total moles of 4,4′-biphenyl dicarboxylate and terephthalate in the diacid component in any of the ranges provided herein total 100 mole percent.

Preferably, the diol component is CHDM; and the diacid component consists essentially of 3,4′-biphenyl dicarboxylate and terephthalate, and/or the total moles of 3,4′-biphenyl dicarboxylate and terephthalate in the diacid component in any of the ranges provided herein total 100 mole percent.

Preferably, the diol component is CHDM; and the diacid component consists essentially of 4,4′-biphenyl dicarboxylate and 3,4′-biphenyl dicarboxylate and/or the total moles of 4,4′-biphenyl dicarboxylate and 3,4′-biphenyl dicarboxylate in the diacid component in any of the ranges provided herein total 100 mole percent.

As another example, when the diol component consists essentially of NPG, the diacid component may comprise from about 10 to 90 (or 20 to 80, or 30 to 70) mole percent 4,4′-biphenyl dicarboxylate, and from about 90 to 10 (or 80 to 20, or 70 to 30) mole percent terephthalate; or from about 10 to 90 (or 20 to 80, or 30 to 70) mole percent 3,4′-biphenyl dicarboxylate, from about 90 to 10 (or 80 to 20, or 70 to 30) mole percent terephthalate; or from about 10 to 90 (or 20 to 80, or 30 to 70) mole percent 4,4′-biphenyl dicarboxylate, from about 90 to 10 (or 80 to 20, or 70 to 30) mole percent 3,4′-biphenyl dicarboxylate; all based on the total moles of the diacid component. Preferably, the diol component is NPG; and the diacid component consists essentially of 4,4′-biphenyl dicarboxylate and 3,4′-biphenyl dicarboxylate and/or the total moles of 4,4′-biphenyl dicarboxylate and 3,4′-biphenyl dicarboxylate in the diacid component in any of the ranges provided herein total 100 mole percent.

Preferably, the diol component is NPG; and the diacid component consists essentially of 4,4′-biphenyl dicarboxylate and terephthalate, and/or the total moles of 4,4′-biphenyl dicarboxylate and terephthalate in the diacid component in any of the ranges provided herein total 100 mole percent.

Preferably, the diol component is NPG; and the diacid component consists essentially of 3,4′-biphenyl dicarboxylate and terephthalate, and/or the total moles of 3,4′-biphenyl dicarboxylate and terephthalate in the diacid component in any of the ranges provided herein total 100 mole percent.

Preferably, the diol component is NPG; and the diacid component consists essentially of 4,4′-biphenyl dicarboxylate and 3,4′-biphenyl dicarboxylate and/or the total moles of 4,4′-biphenyl dicarboxylate and 3,4′-biphenyl dicarboxylate in the diacid component in any of the ranges provided herein total 100 mole percent.

Preferably, the composition of the diol component is selected to control morphology, the amount of crystallinity, mechanical properties, the glass transition temperature Tg, and/or the melting temperature Tm. Preferably, the diol component consists essentially of CHDM or NPG, which is present in the copolyester along with a selected mixture of diacid components, the composition of the mixture being selected to be present in an amount effective to control crystallinity, mechanical properties, the glass transition temperature Tg, and/or the melting temperature Tm.

In any embodiment, the polymer may further comprise a branching agent as defined above, e.g., a multifunctional hydroxyl or carboxylic acid compound, preferably a multifunctional acid compound such as trimellitic or pyromellitic anhydride, and/or a multifunctional polyol compound such as glycerol, sorbitol, hexane triol-1,2,6, pentaerythritol, or trimethylolethane. Generally, the branching agent can be present in an amount effective to reduce the crystallinity and/or the rate of crystallization, and/or up to an amount that does not result in significant crosslinking, e.g., the copolyester can be essentially free of crosslinking or gel formation. In any embodiment, the copolymer can comprise an amount of trimellitic anhydride suitable to form a measurable amount of long chain branching in the copolymer, as determinable by DSC analysis at a heating rate of 10° C./min, ¹H NMR analysis, or ¹³C NMR analysis.

In any embodiment, the method may comprise contacting (i) a diol component comprising, or preferably consisting essentially of or consisting of neopentyl glycol (NPG), with (ii) a diacid component comprising a biphenyl dicarboxylate, preferably a diacid selected from 4,4′-biphenyl dicarboxylate and 3,4′-biphenyl dicarboxylate, and forming a polyester comprising the diol and diacid components, preferably wherein the polyester has an amorphous morphology. The method may further comprise forming the polyester into a shaped article, and/or into a fiber, a nonwoven fabric, a film, or a molded article.

In any embodiment of the invention, the copolyester can comprise equal to or greater than about 0.001 mole percent of the branching agent (e.g., a polycarboxylic acid moiety or ester producing derivative thereof), based on the total moles of repeating units in the copolyester. For example, the branching agent (e.g., trimellitic anhydride or glycerol) may be present at from about 0.001 to 1 mole percent, or from about 0.005 to 0.5 mole percent, or from about 0.01 to 0.5 mole percent, or from about 0.02 to 0.3 mole percent, or from about 0.05 to 0.3 mole percent, or from about 0.1 to 0.3 mole percent, based on the total moles of repeating units in the copolyester.

In embodiments which include a diol consisting essentially of CHDM and a diacid component consisting essentially of 3,4′-biphenyl dicarboxylate and terephthalate, as the 3,4′-biphenyl dicarboxylate concentration is increased from about 40 mole percent up to 60 mole percent, an amorphous copolyester can be produced in which the glass transition temperature increases from 105° C. to 110° C. at 40 mole percent 3,4′-biphenyl dicarboxylate, up to greater than 110° C. at 60 mole percent 3,4′-biphenyl dicarboxylate. Accordingly, the composition of the diol component and the composition of the diacid component is preferably selected to control the glass transition temperature, the morphology, the zero shear melt viscosity, or other properties of the copolyester.

In any embodiment according to the present invention, the glass transition temperature, and/or the morphology of the copolyester, and/or other properties can be controlled by selecting the amounts of the 4,4′-biphenyl dicarboxylate, 3,4′-biphenyl dicarboxylate, terephthalate or isophthalate, and/or selecting the diol component, e.g., either NPG or CHDM. In general, when utilizing CHDM as the diol, increasing the relative amount of the 4,4′-biphenyl dicarboxylate to the other diacids present increases the glass transition temperature; and at the same time, increasing the relative amount of the 4,4′-biphenyl dicarboxylate can increase the degree of crystallinity, whereas increasing the relative amount of the 3,4′-biphenyl dicarboxylate and/or utilizing NPG tends to decrease the degree of crystallinity and decrease the glass transition temperature. In this manner, the glass transition temperature and degree of crystallinity can be balanced as desired.

In one example, the copolyester can comprise a semicrystalline morphology; preferably having a diol component consisting essentially of CHDM and a diacid component comprising from about 20 to 80 mole percent 4,4′-biphenyl dicarboxylate and from about 80 to 20 mole percent terephthalate, based on the total moles of the diacid component in the polyester; a glass transition temperature equal to or greater than about 90° C., or 100° C., or 110° C., or 120° C.; and a melting temperature of greater than 230° C. and less than or equal to about 250° C. Preferably, the diacid component comprises from about 50 to 75 mole percent 4,4′-biphenyl dicarboxylate and from about 50 to 25 mole percent terephthalate, based on the total moles of the diacid component in the copolyester.

In any embodiment, the invention can provide a shaped article comprising any of the copolyester embodiments described above, e.g., in the form of a fiber, a nonwoven fabric, a film, or a molded article.

Generally, a method comprises: contacting (i) a diol component comprising a diol selected from one of 1,4-cyclohexanedimethanol (CHDM) and neopentyl glycol (NPG); with (ii) a diacid component comprising: a combination of first and second diacids selected from the group consisting of 4,4′-biphenyl dicarboxylic acid (4,4′-BB), 3,4′-biphenyl dicarboxylic acid (3,4′-BB), and terephthalic acid, or ester producing equivalents thereof; in the presence of (iii) a catalyst; and forming a copolyester comprising the diol and diacid components.

In any embodiment of the method, the diol and diacid components, are as described above in connection with the copolyesters, which, in some embodiments, can be made by the present method. For example, the diol component can consist essentially of CHDM, or consists essentially of NPG; and/or the diacid component consists essentially of the first and second diacids, or ester producing equivalents thereof. Generally, the diacid component can further comprise up to 5 mole percent of other diacids, or ester producing equivalents thereof, based on the total moles of the diacid component in the copolyester.

Preferably, the diacid component in the method comprises from about 10 to 90 mole percent 4,4′-BB and from about 90 to 10 mole percent terephthalic acid, or ester producing equivalents thereof, based on the total moles of the diacid component in the copolyester. In any embodiment, the diacid component can further comprise up to 5 mole percent of isophthalic acid, 3,4′-BB, ester producing equivalents thereof, or a combination thereof, based on the total moles of the diacid component in the copolyester.

Preferably, the diacid component in the method comprises from about 10 to 90 mole percent 3,4′-BB and from about 90 to 10 mole percent terephthalic acid, or ester producing equivalents thereof, based on the total moles of the diacid component in the copolyester. In any embodiment, the diacid component can further comprise up to 5 mole percent of isophthalic acid, 4,4′-BB, ester producing equivalents thereof, or a combination thereof, based on the total moles of the diacid component in the copolyester.

Preferably, the diacid component in the method comprises from about 10 to 90 mole percent 3,4′-BB and from about 90 to 10 mole percent 4,4′-BB, or ester producing equivalents thereof, based on the total moles of the diacid component in the copolyester. In some embodiments, the diacid component further comprises up to 5 mole percent of isophthalic acid, terephthalic acid, ester producing equivalents thereof, or a combination thereof, based on the total moles of the diacid component in the copolyester.

In any embodiment of the method, the polymer may further comprise less than or equal to 5 mole percent of a branching agent, e.g., a multifunctional hydroxyl or carboxylic acid compound, preferably a multifunctional acid compound, such as trimellitic or pyromellitic anhydride or a multifunctional polyol such as glycerol, sorbitol, hexane triol-1,2,6, pentaerythritol, or trimethylolethane. In some embodiments of the invention, the branching agent is present in an amount effective to reduce the crystallinity and/or the rate of crystallization, and/or up to an amount that does not result in significant crosslinking, e.g., the copolyester can be essentially free of crosslinking or gel formation. Often, the copolymer comprises an amount of trimellitic anhydride suitable to form a measurable amount of long chain branching in the copolymer, as determinable by DSC analysis at a heating rate of 10° C./min, ¹H NMR analysis, or ¹³C NMR analysis.

In any embodiment of the method, the copolyester may comprise equal to or greater than about 0.001 mole percent of the branching agent (e.g., a tricarboxylic acid moiety or ester producing derivative thereof, or a triol), based on the total moles of repeating units in the copolyester. For example, the branching agent (e.g., trimellitic anhydride or glycerol) may be present at from about 0.001 to 5 mole percent, or from about 0.005 to 1 mole percent, or from about 0.01 to 0.5 mole percent, or from about 0.02 to 0.3 mole percent, or from about 0.05 to 0.3 mole percent, or from about 0.1 to 0.3 mole percent, based on the total moles of repeating units in the copolyester. In some embodiments, the diacid component of the polymer consists essentially of 4,4′-biphenyl dicarboxylic acid combined with trimellitic anhydride, or 3,4′-biphenyl dicarboxylic acid, and trimellitic anhydride.

In any embodiment, the copolyester made by the method can comprise a number average molecular weight of equal to or greater than about 5,000 g/mol.

In any embodiment, the copolyester made by the method can comprise a glass transition temperature equal to or greater than about 90° C., or equal to or greater than 100° C., or equal to or greater than 105° C., or equal to or greater than 110° C., or equal to or greater than 115° C., or equal to or greater than 120° C., or equal to or greater than 125° C., or equal to or greater than 130° C., or equal to or greater than 135° C.

In any embodiment, the copolyester made by the method can exhibit a zero shear melt viscosity less than 1700 Pa·s, determined according to ASTM D3835 at 275° C.

In any embodiment, the copolyester made by the method can comprise an essentially amorphous morphology.

In any embodiment, the copolyester made by the method can comprise a semi-crystalline morphology, preferably having a melting point of less than 270° C.

In general, the method can further comprise forming the copolyester into a shaped article. For example, the method can comprise forming the copolyester into a fiber, a nonwoven fabric, a film, or a molded article.

In any embodiment of the invention, the copolyesters may be prepared by melt polymerization techniques including transesterification and polycondensation, in batch, semi-batch, or continuous processes. The copolyesters are preferably prepared in a reactor equipped with a stirrer, an inert gas (e.g., nitrogen) inlet, a thermocouple, a distillation column connected to a water-cooled condenser, a water separator, and a vacuum connection tube. For example, the equipment and procedures disclosed in U.S. Pat. Nos. 4,093,603 and 5,681,918, incorporated by reference herein, may be adapted for implementing the present invention.

In any embodiment, polycondensation processes may include melt phase processes conducted with the introduction of an inert gas stream, such as nitrogen, to shift the equilibrium and advance to high molecular weight and/or vacuum melt phase polycondensation at temperatures above about 150° C. and pressures below about 130 Pa (1 mm Hg). The esterification conditions can generally include an esterification catalyst, preferably in an amount from about 0.05 to 1.5 percent by weight of the reactants; optional stabilizers, such as, for example, phenolic antioxidants such as IRGANOX 1010 or phosphonite- and phosphite-type stabilizers such as tributylphosphite, preferably in an amount from 0 to 1 percent by weight of the reactants; a temperature which is gradually increased from about 130° C. in the initial reaction steps up to about 190 to 280° C. in the later steps, initially under normal pressure, then, when necessary, under reduced pressure at the end of each step, while maintaining these operating conditions until a copolyester with the desired properties is obtained. If desired, the degree of esterification may be monitored by measuring the amount of water formed and the properties of the copolyester, for example, viscosity, hydroxyl number, acid number, and so on.

In any embodiment, the polymerization reaction to produce the copolyesters may be carried out in the presence of one or more esterification catalysts as mentioned above. Suitable catalysts may also include those disclosed in U.S. Pat. Nos. 4,025,492; 4,136,089; 4,176,224; 4,238,593; and 4,208,527, which are hereby incorporated herein by reference. Suitable catalyst systems may include compounds of Ti, Ti/P, Mn/Ti/Co/P, Mn/Ti/P, Zn/Ti/Co/P, Zn/Al, Sb (e.g., Sb₂O₃), Sn (e.g., dibutyltin oxide, dibutyltin dilaurate, n-butyltin trioctoate), and so on. When cobalt is not used in the polycondensation, copolymerizable toners may be incorporated into the copolyesters to control the color of these copolyesters so that they are suitable for the intended applications where color may be an important property. In addition to the catalysts and toners, other additives, such as antioxidants, dyes, etc., may be used during the copolyesterification, or may be added after formation of the polymer.

In general, the copolyesters may include conventional additives including pigments, colorants, stabilizers, antioxidants, extrusion aids, reheat agents, slip agents, carbon black, flame retardants, and mixtures thereof. In any embodiment, the copolyester may be combined or blended with one or more modifiers and/or blend polymers including polyamides; e.g., NYLON 6,6® (DuPont), poly(ether-imides), polyphenylene oxides, e.g., poly(2,6-dimethylphenylene oxide), poly(phenylene oxide)/polystyrene blends; e.g., NORYL® (SABIC Innovative Plastics), other polyesters, polyphenylene sulfides, polyphenylene sulfide/sulfones, poly(ester-carbonates), polycarbonates; e.g., LEXAN® (SABIC Innovative Plastics), polysulfones, polysulfone ethers, poly(ether-ketones), combinations thereof, and the like.

Any of the copolyesters and compositions described herein may be used in the preparation of molded products in any molding process, including but not limited to, injection molding, gas-assisted injection molding, extrusion blow molding, injection blow molding, injection stretch blow molding, compression molding, rotational molding, foam molding, thermoforming, sheet extrusion, and profile extrusion. The molding processes are well known to those of ordinary skill in the art. The polyester compositions described above may also be used in the preparation of nonwoven fabrics and fibers. In any embodiment, a shaped article such as an extruded profile or an extruded or injection molded article can comprise one or more copolyesters according to one or more embodiments disclosed herein. Accordingly, in any embodiment, copolyesters according to the instant invention can generally be molded and extruded using conventional melt processing techniques to produce a shaped article. Such articles may be transparent. The shaped articles manufactured from the copolyesters disclosed herein generally exhibit improved properties as shown in the examples below.

Shaped articles comprising any embodiment of the polymers disclosed herein may generally be produced using thermoplastic processing procedures such as injection molding, calendaring, extrusion, blow molding, extrusion blow molding, rotational molding, and so on. The amorphous and/or semicrystalline copolyesters of the present invention preferably exhibit improved stability at various melt temperatures. In the conversion of the copolyesters into shaped articles, the moisture content of copolyesters according to the present invention may often be reduced to less than about 0.02 percent prior to melt processing.

### EXAMPLES

In the following examples, dimethyl 4,4′-biphenyl dicarboxylate (4,4′BB) and dimethyl 3,4′-biphenyl dicarboxylate (3,4′BB) were supplied by EXXONMOBIL. Dimethyl terephthalate (DMT) (≥99%) was purchased from Sigma-Aldrich. These diacid esters were dried under vacuum at 35° C. for at least 16 hours and stored in a desiccator before use. 1,4-Cyclohexanedimethanol (CHDM) with a 30:70 ratio of cis:trans isomers was purchased from SIGMA-ALDRICH (mixture of cis and trans, ≥99%) and used as received. 2,2-Dimethyl-1,3-propanediol (neopentylglycol or NPG, 99%) was obtained from a commercial source and used as received. Titanium (IV) butoxide (97%) was purchased from SIGMA-ALDRICH, and 0.02-0.06 g/mL titanium solutions in anhydrous 1-butanol were prepared. All solvents, nitrogen gas (Praxair, 99.999%), oxygen gas (Airgas, 100%) and other gases were obtained from commercial sources and used as received. Dichloroacetic acid (≥99%) was purchased from Acros Organics. All other solvents were obtained from Spectrum.

In the following examples, the DMT-BB copolyester copolymers are named according to a shorthand notation, wherein the name indicates the relative molar proportions of the various comonomers present therein. Polyester copolymers comprising DMT are named using the abbreviation “T,” prefixed by the mol % T, followed by the comonomer ester prefixed by the mol % of the comonomer ester. The sum of the mol % of the DMT and the comonomer ester is 100. For example, a 60 mol % DMT with 40% 4,4′BB diesters and 100% CHDM diol content is named as 60-T-40-4,4′BB-CHDM.

In the following examples, the scale of the copolymer synthesis may be indicated, where relevant, by a suffix following the copolymer notation. For example, a copolymer produced on a 20-30 g scale may be followed by “(20-30 g)” and a copolymer produced on a 100-150 g scale by “(100-150 g).”

Compression Molding of Copolyesters:

All polymers were melt pressed between two aluminum plates, layered with KAPTON® films using a PHI Q-230H manual hydraulic compression press. Aluminum shims were inserted to control the film thickness. REXCO PARTALL® power glossy liquid mold release agent was applied to the KAPTON® films to facilitate release of the polyesters. Samples were heated at 275° C. for 1 minute for amorphous polyesters or 3 minutes for semi-crystalline polyesters before the top stainless steel plate was added. The plates were then centered in the press and closed until there was no visible gap between plates. After two more minutes of heating at 275° C., four 30-second press-release-press cycles were completed with the first two presses utilizing 44.5 kN (5 tons) force and the last two presses utilizing 89 kN (10 tons) force. After the final press, the aluminum plates were immediately submersed in an ice water bath to quench cool the samples. Films were then isolated and dried in a vacuum oven at 40° C. overnight before further characterizations.

NMR analysis:

¹H NMR spectra were acquired on a BRUKER AVANCE II 500 MHz instrument with a minimum of 32 scans at 23° C. Samples were dissolved (ca. 50 mg/mL) in mixtures of TFA-d and CDCl₃ (approximately 5:95 v/v) and chemical shifts are measured with respect to internal tetramethylsilane (TMS). Quantitative ¹³C NMR confirmed that melt-phase polymerization produced completely random copolymers.

Viscosity Analysis:

Inherent viscosities (IV) were measured in 0.5% (g/dL) dichloroacetic acid solution at 25° C. by means of a CANNON TYPE B glass capillary viscometer, adapted from ASTM method D4603. Inherent viscosity at 0.5 g/dL dichloroacetic acid solution was used to calculate intrinsic viscosity according to the method outlined by Ma et al., “Fiber Spinning, Structure, and Properties of Poly(ethylene terephthalate-co-4, 4′-bibenzoate) Copolyesters”, Macromolecules, 2002, 35, 5123-5130. Some examples of the copolyesters disclosed herein achieved high inherent viscosities in the range of 0.8-0.9 dL/g, or more which corresponds to viscosity-average molecular weight of 26,600-30,700 g/mol, based on the empirical Mark-Houwink equation in which k=1.7×10⁻⁴ and α=0.83.

Thermogravimetric Analysis:

Thermogravimetric analysis (TGA) of polymer samples (˜10 mg) were analyzed using TGA Q500 (TA Instruments, New Castle, Del.) at a heating rate of 10° C./min from 30° C. to 600° C. under nitrogen. All of the synthesized materials were thermally stable up to 360-400° C. or more.

Differential Scanning Calorimetry:

Differential scanning calorimetry (DSC) was conducted using Q2000 (TA Instruments, New Castle, Del.), calibrated with indium and tin standards. A small piece of polymer film (5 mg) was analyzed in a TZERO′ pan under a nitrogen atmosphere with heating and cooling rates of 10° C./min. The sample was held at temperature for 3 min between heating and cooling scans. Glass transition temperatures were measured as the midpoint of the transition in the second heating ramp.

Tensile Testing:

Dogbone samples were injection molded for tensile testing on a BOY-XS injection molding machine, with mold temperature of 7° C. (45° F.); barrel temperatures: 275° C.-290° C.; holding pressure: 6.9 MPa (1000 psi); and cycle time: ˜60 sec and were used for measurements without additional conditioning. Tensile testing was conducted on an INSTRON 5500R with a crosshead motion rate of 10 mm/min and an initial grip separation of 25.4±2.0 mm, and on an MTS Model No. 4204 with a lkN load cell and a crosshead motion rate of 5 mm/min (before 5% strain) and 10 mm/min (after 5% strain) with an initial grip-to-grip separation of 25.4±2.0 mm. Tensile modulus was estimated by crosshead displacement, but would likely be lower possibly due to sample slippage, which artificially increased the measured strain. In ASTM D638, an extensometer is generally used in the initial portion of the test to determine strain. An Epsilon 3442 miniature extensometer was therefore attached to more accurately measure the tensile modulus.

### Example 1. Synthesis of 55-4,4′BB-45-T-CHDM Copolyester

The polymerization was performed in a dry 100 mL round-bottomed flask equipped with an overhead stirrer, nitrogen inlet, and distillation apparatus. DMT (8.74 g, 45 mmol eq.) and 4,4′BB (14.87 g, 55 mmol eq.) and CHDM (15.86 g, 110 mmol eq.) were charged to the flask. Titanium butoxide solution (40 ppm of Ti to the theoretical yield) was injected to the flask and used to catalyze the reaction. Degassing with vacuum and purging with nitrogen three times allowed the reaction to proceed oxygen free. The flask was submerged in a metal bath and the reaction proceeded at 180° C. for 1 h, 200° C. for 1 h, 220° C. for 2 h, all under constant stirring at 200 rpm and nitrogen purge. The bath was again heated up to 300° C. in 20-30 minutes, vacuum was then slowly applied during the course of 1 hour until it reached equilibrium at around 0.1 mmHg, meanwhile the overhead stirrer was kept stirring at the slowest motor speed of 20-30 rpm to minimize polymer wrapping on the metal rod. The resulting polymer was removed from the flask, washed with DI water and vacuum dried at 100° C. Tg 122° C.; Tc 198° C.; Tm 245° C.; ΔHm 7.8 J/g DSC (cooling, 10° C./min): No Tc ¹H NMR (in TFA-d/CDCl₃): T:4,4′BB=45.1:54.9; cis:trans (CHDM): 27.9:72.1.

### Examples 2-8

Polymers made with CHDM diol were synthesized using a similar procedure to the following illustrative synthesis of 50-T-50-3,4′BB-CHDM copolyester (Example 7, 20 g scale). Reactions were performed in a dry 100 mL round bottom flask equipped with an overhead stirrer, a distillation arm and a nitrogen inlet. CHDM (11.1 g, 1.2 mol eq.), DMT (6.2 g, 0.5 mol eq.) and 3,4′BB (8.7 g, 0.5 mol eq.) were charged into the flask along with titanium butoxide solution (40 ppm Ti to the theoretical yield). Reactions were degassed with vacuum and purged with nitrogen three times to remove oxygen. The reaction flask was submerged in a metal bath and stirred at 200° C. for 1 h, then 220° C. for 2 h, then 280° C. for 1 h, all while continually purging with nitrogen and stirring at 250 rpm. Vacuum was then slowly applied over the course of one hour until a pressure of 0.1-0.3 mmHg was reached and the stirring speed was reduced to 30-40 rpm. The polymer was then removed from the flask, rinsed with DI water and vacuum dried overnight at 10-20° C. above the polymer glass transition temperature. For other polymers, the type and relative amounts of diacid were selected as needed.

### Examples 9-11

All polymers made with NPG diol were synthesized using a similar procedure to the following illustrative synthesis of 50-T-50-3,4′BB-NPG copolyester (Example 9, 20 g scale). Reaction setup was the same as for Examples 2-8 except NPG was charged at 1.7 molar equivalents, transesterification ran at 230° C. for 3 hr and polycondensation ran at 280° C. for 2 hr. For other polymers, the type and relative amounts of diacid were selected as needed.

The copolyester compositions are shown in Table 1 and the physical properties are shown in Table 2.

TABLE 1

| | | Diacid¹ (mole percent) | | | Tg | Tm |
|---|---|---|---|---|---|---|
| Example | Diol | 4,4′BB | 3,4′BB | T | (° C.) | (° C.) |
| 1 | CHDM | 55 | | 45 | 122 | 245 |
| 2 | CHDM | 56 | 44 | | 135 | 237 |
| 3 | CHDM | 47 | 53 | | 128 | N/D |
| 4 | CHDM | 26 | 74 | | 123 | N/D |
| 5 | CHDM | 0 | 100 | | 121 | N/D |
| 6 | CHDM | | 40 | 60 | 111 | N/D |
| 7 | CHDM | | 50 | 50 | 108 | N/D |
| 8 | CHDM | | 60 | 40 | 106 | N/D |
| 9 | NPG | 49 | 51 | | 110 | N/D |
| 10 | NPG | 53 | | 47 | 101 | N/D |
| 11 | NPG | | 52 | 48 | 93 | N/D |
| 12 | NPG | 100 | | | 116 | N/D |
| 13 | EG | 95 | | 5 | 124 | 350 |
| 14 | NPG | | 100 | | 104 | N/D |
| 15 | EG | | 100 | | 104 | N/D |
| 16 | NPG | | | 100 | 77 | N/D |
| 17² | EG | | | 100 | 81 | 252 |

N/D = not detected;
¹Diacid proportions from ¹NMR;
²Commercial PET 418 from Scientific Polymer Products, Inc.

TABLE 2

| | | | | | Zero Shear | | Tensile | Elong. | |
|---|---|---|---|---|---|---|---|---|---|
| | | | | | Viscosity | Yield | Stress at | to | Young's |
| | | Tg, | Tm, | IV, | @275° C., | Stress, | Break, | Break, | Mod., |
| Ex. | Morph. | ° C. | ° C. | dL/g | Pa*s | MPa | MPa | % | GPa |
| 1 | SC | 122 | 245 | | | | | | |
| 2 | SC | 135 | 237 | | 6700 | 35.9 | 48.3 | 79.4 | 1.73 |
| 3 | A | 128 | N/D | | 1300 | 39.4 | 56.2 | 104 | 1.92 |
| 4 | A | 123 | N/D | | 1600 | 44.1 | 51.3 | 86.2 | 2.06 |
| 5 | A | 121 | N/D | 0.74 | 6100 | 46.5 | 63 | 120 | 2.04 |
| 6 | A | 111 | N/D | 0.86 | | 49.4 ± 0.3 | 65.9 ± 4.4 | 137.9 ± 14.5 | 1.513 |
| 7 | A | 108 | N/D | 0.76 | | 47.5 ± 1.5 | 52.6 ± 3.7 | 104.7 ± 8.7 | 1.637 |
| 8 | A | 106 | N/D | 0.79 | | 47.4 ± 0.8 | 56.4 ± 4.6 | 117.9 ± 16.5 | 1.419 |
| 9 | A | 110 | N/D | 0.74 | | | | | |
| 10 | A | 101 | N/D | 0.92 | | 48.4 ± 0.6 | 52.1 ± 4.5 | 152.2 ± 24.2 | 1.797 |
| 11 | A | 93 | N/D | 0.76 | | | | | |

SC = semi-crystalline; A = amorphous; N/D = not detected; IV = inherent viscosity.

As these data show, incorporation of diacids with diols such as 1,4-cyclohexanedimethanol (CHDM) or 2,2′-dimethyl-1,3-propane diol (NPG) results in copolyesters having enhanced properties, e.g., Tg. By selecting the various diacids and their relative concentrations, reduced crystallization rates were observed. In addition, the compositional variations enabled control of the glass transition temperature of the polymer.

It has been discovered that the incorporation of 4,4′-BB units combined with 3,4′-BB or terephthalic acid, or 3,4′-BB and terephthalic acid, with either NPG or CHDM, leads to significantly enhanced Tg and other properties compared to the conventional acid modified amorphous copolyesters consisting of terephthalic acid and isophthalic acid mixtures. The use of 4,4′-BB-T compositions results in copolyesters, which may be classified as semicrystalline, which is thought to be due to the chain symmetry. Enhanced glass transition temperatures are also achieved. These data also show that the addition of various levels of terephthalate or isophthalate into a copolyester based on of 4,4′-BB or 3,4′-BB with a single diol yields copolyesters with excellent properties, which are unexpected based on what is known about acid modified amorphous copolyesters. For example, the Tg of 50-T-50-3,4′BB-CHDM copolyester has a Tg of 110° C. vs. only 88° C. for 70-T-30-I.

In examples 12-17, it is seen that NPG has an unexpected influence on the morphology and Tg of the bibenzoate polyesters. As Example 12 shows, the 4,4′-BB-NPG homopolymer has amorphous morphology and lower Tg relative to the mixed diacids based on CHDM in Examples 1-4 or on EG in Example 13. The ability of NPG to suppress crystallinity in 4,4′-BB polyesters as seen in Examples 9, 10, and 12 is unexpected in view of the difficulty of obtaining an amorphous polyesters with a high 4,4′-BB content as seen in Examples 1,2, and 13. Also unexpected is the effect of NPG on Tg in the bibenzoate polyesters, which is increased in 4,4′-BB-NPG-CHDM copolyesters (e.g., 4,4′BB-54-NPG-46-CHDM has Tg 129° C. and Tm not detected) relative to EG-CHDM copolyesters (e.g., 4,4′BB-60-EG-40-CHDM has Tg 94° C. and Tm 278° C.), which is unchanged in the 3,4-BB polyesters, e.g., 3,4′-BB-EG (Example 15) and 3,4′-BB-NPG (Example 14) both have Tg of 104° C., and decreased in the 4,4′-BB-NPG polyesters of Examples 9, 10, and 12 relative to the CHDM- and EG based copolyesters of Examples 1-4 and 13.

Although only a few example embodiments have been described in detail above, those skilled in the art will readily appreciate that many modifications are possible in the example embodiments without materially departing from this invention. Accordingly, all such modifications are intended to be included within the scope of this invention as defined in the following claims. It is the express intention of the applicant not to invoke 35 U.S.C. § 112(f) for any limitations of any of the claims herein, except for those in which the claim expressly uses the words ‘means for’ together with an associated function and without any recitation of structure. The priority document is incorporated herein by reference.

1. A copolyester comprising:
a diol component comprising a diol selected from one of 1,4-cyclohexanedimethanol (CHDM) and neopentyl glycol (NPG); and
a diacid component comprising a combination of first and second diacids selected from the group consisting of 4,4′-biphenyl dicarboxylate, 3,4′-biphenyl dicarboxylate, and terephthalate.

2. The copolyester of claim 1, wherein the diol component consists or consists essentially of CHDM, or consists or consists essentially of NPG.

3. The copolyester of claim 1, wherein the diacid component consists essentially of the first and second diacids.

4. The copolyester of claim 3, wherein the diacid component further comprises up to 5 mole percent of another diacid, preferably isophthalate, based on the total moles of the diacid component in the copolyester.

5. The copolyester of claim 1, wherein the diacid component is selected from:
(a) from about 10 to 90 mole percent 4,4′-biphenyl dicarboxylate and from about 90 to 10 mole percent terephthalate, based on the total moles of the diacid component in the copolyester; or
(b) from about 10 to 90 mole percent 4,4′-biphenyl dicarboxylate and from about 90 to 10 mole percent terephthalate, and optionally further comprises up to 5 mole percent of isophthalate, 3,4′-biphenyl dicarboxylate, or a combination thereof, based on the total moles of the diacid component in the copolyester; or
(c) from about 10 to 90 mole percent 3,4′-biphenyl dicarboxylate and from about 90 to 10 mole percent terephthalate, based on the total moles of the diacid component in the copolyester; or
(d) from about 10 to 90 mole percent 3,4′-biphenyl dicarboxylate and from about 90 to 10 mole percent terephthalate, and optionally further comprises up to 5 mole percent of isophthalate, 4,4′-biphenyl dicarboxylate, or a combination thereof, based on the total moles of the diacid component in the copolyester;
(e) from about 10 to 90 mole percent 3,4′-biphenyl dicarboxylate and from about 90 to 10 mole percent 4,4′-biphenyl dicarboxylate, based on the total moles of the diacid component in the copolyester; or
(f) from about 10 to 90 mole percent 3,4′-biphenyl dicarboxylate and from about 90 to 10 mole percent 4,4′-biphenyl dicarboxylate, and optionally further comprises up to 5 mole percent of isophthalate, terephthalate, or a combination thereof, based on the total moles of the diacid component in the copolyester.

6. The copolyester of claim 1, further comprising an inherent viscosity equal to or greater than about 0.5 dL/g.

7. The copolyester of claim 1, wherein the copolyester has a glass transition temperature equal to or greater than about 90° C., or equal to or greater than 95° C., or equal to or greater than 100° C., or equal to or greater than 105° C., or equal to or greater than 110° C., or equal to or greater than 115° C., or equal to or greater than 120° C., or equal to or greater than 125° C., or equal to or greater than 130° C., or equal to or greater than 135° C.

8. The copolyester of claim 1, wherein the copolyester has a zero shear melt viscosity less than 1700 Pa·s, or less than 1500 Pa·s, or less than 1300 Pa·s, or less than 1100 Pa·s, determined according to ASTM D3835 at 275° C.

9. The copolyester of claim 1, having an essentially amorphous morphology.

10. The copolyester of any of claim 1, having a semi-crystalline morphology, preferably having a melting point of less than 270° C.

11. A copolyester comprising: poly(4,4′-biphenyl dicarboxylate-co-3,4′-biphenyl dicarboxylate)-CHDM; or poly(4,4′-biphenyl dicarboxylate-co-terephthalate)-CHDM; or poly(3,4′-biphenyl dicarboxylate-co-terephthalate)-CHDM; or poly(4,4′-biphenyl dicarboxylate-co-3,4′-biphenyl dicarboxylate)-NPG; or poly(4,4′-biphenyl dicarboxylate-co-terephthalate)-NPG; or poly(3,4′-biphenyl dicarboxylate-co-terephthalate)-NPG.

12. A shaped article comprising the copolyester of claim 1.

13. The shaped article of claim 12, wherein the copolyester is in the form of a fiber, a nonwoven fabric, a film, or a molded article.

14. A method, comprising:
contacting (i) a diol component comprising a diol selected from one of 1,4-cyclohexanedimethanol (CHDM) and neopentyl glycol (NPG);
with (ii) a diacid component comprising: a combination of first and second diacids selected from the group consisting of 4,4′-biphenyl dicarboxylic acid (4,4′-BB), 3,4′-biphenyl dicarboxylic acid (3,4′-BB), and terephthalic acid, or ester producing equivalents thereof;
in the presence of (iii) a catalyst; and
forming a copolyester comprising the diol and diacid components.

15. The method of claim 14, wherein the diol component consists essentially of CHDM, or consists essentially of NPG.

16. The method of claim 14, wherein the diacid component consists essentially of the first and second diacids, or ester producing equivalents thereof.

17. The method of claim 16, wherein the diacid component further comprises up to 5 mole percent of other diacids, or ester producing equivalents thereof, based on the total moles of the diacid component in the copolyester.

18. The method of claim 14, wherein the diacid component comprises from about 10 to 90 mole percent 4,4′-BB and from about 90 to 10 mole percent terephthalic acid, or ester producing equivalents thereof, based on the total moles of the diacid component in the copolyester.

19. The method of claim 18, wherein the diacid component further comprises up to 5 mole percent of isophthalic acid, 3,4′-BB, ester producing equivalents thereof, or a combination thereof, based on the total moles of the diacid component in the copolyester.

20. The method of claim 1, wherein the diacid component comprises from about 10 to 90 mole percent 3,4′-BB and from about 90 to 10 mole percent terephthalic acid, or ester producing equivalents thereof, based on the total moles of the diacid component in the copolyester.

21. The method of claim 20, wherein the diacid component further comprises up to 5 mole percent of isophthalic acid, 4,4′-BB, ester producing equivalents thereof, or a combination thereof, based on the total moles of the diacid component in the copolyester.

22. The method of claim 14, wherein the diacid component comprises from about 10 to 90 mole percent 3,4′-BB and from about 90 to 10 mole percent 4,4′-BB, or ester producing equivalents thereof, based on the total moles of the diacid component in the copolyester.

23. The method of claim 22, wherein the diacid component further comprises up to 5 mole percent of isophthalic acid, terephthalic acid, ester producing equivalents thereof, or a combination thereof, based on the total moles of the diacid component in the copolyester.

24. The method of claim 14, wherein the copolyester has an inherent viscosity equal to or greater than about 0.5 dL/g.

25. The method of claim 14, wherein the copolyester has a glass transition temperature equal to or greater than about 90° C., or equal to or greater than 100° C., or equal to or greater than 105° C., or equal to or greater than 110° C., or equal to or greater than 115° C., or equal to or greater than 120° C., or equal to or greater than 125° C., or equal to or greater than 130° C., or equal to or greater than 135° C.

26. The method of claim 14, wherein the copolyester exhibits a zero shear melt viscosity less than 1700 Pa·s determined according to ASTM D3835 at 275° C.

27. The method of claim 14, wherein the copolyester has an essentially amorphous morphology.

28. The method of claim 14, wherein the copolyester has a semi-crystalline morphology, preferably having a melting point of less than 270° C.

29. The method of claim 14, further comprising forming the copolyester into a shaped article.

30. The method of claim 14, further comprising forming the copolyester into a fiber, a nonwoven fabric, a film, or a molded article.
